(19) United States
(12) Patent Application Publication
(10) Pub. No.: US 2026/0153760 A1
(43) Pub. Date: Jun. 4, 2026

(54) CMOS-POCKELS EFFECT MATERIAL INTEGRATED PHOTONICS DEVICES

(71) Applicant: HyperLight Corporation, Cambridge, MA (US)

(72) Inventors: Christopher Cole, Redwood City, CA (US); Christian Reimer, Wellesley, MA (US); David Allouche, Belmont, CA (US); Robert David Zucker, Half Moon Bay, CA (US); Derek Matthew Kita, Somerville, MA (US)

(21) Appl. No.: 19/334,623

(22) Filed: Sep. 19, 2025

Related U.S. Application Data
(60) Provisional application No. 63/697,252, filed on Sep. 20, 2024.

(51) Int. Cl. G02F 1/035; G02F 1/03

(52) U.S. Cl. CPC G02F 1/0356; G02F 1/0327

(57) ABSTRACT

A photonics device is described. The photonics device includes a plurality of unit cells. Each of the unit cells includes a first portion of a waveguide, an electrode section proximate to the first portion of the waveguide, and an integrated circuit (IC) driver coupled to and configured to drive the electrode section. The unit cells are adjacent and distributed along a second portion of the waveguide. The waveguide includes at least one electro-optic material possessing a Pockels Effect. The waveguide is also configured to carry an optical signal. The IC driver, the electrode section, and the first portion of the waveguide for each of the unit cells are integrated into the photonics device. The unit cells are configured such that the photonics device has a 3 dB bandwidth of at least 70 GHz and the first portion of the waveguide has a length not exceeding five hundred micrometers.

### CROSS REFERENCE TO OTHER APPLICATIONS

This application claims priority to U.S. Provisional Patent Application No. 63/697,252 entitled CMOS-POCKELS EFFECT MATERIAL INTEGRATED PHOTONICS DEVICES filed Sep. 20, 2024 which is incorporated herein by reference for all purposes.

### BACKGROUND OF THE INVENTION

Optical modulators and other electro-optic devices are generally desired to meet certain performance benchmarks. For example, an optical modulator is desired to be capable of providing a sufficient optical modulation at particular electrode driving voltages. Current applications of electro-optic devices may require faster modulators (higher bandwidth) and lower power. Lower power modulators generally correspond to lower voltage swings used to drive the electrodes for the optical modulator. This may be achieved in part by utilizing materials with a large electro-optic effect. For example, materials such as lithium niobate and/or lithium tantalate that possess the Pockels Effect may provide a larger modulation for a given voltage applied to the electrode. In addition, the voltage can be reduced by making modulators longer. However, for materials that possess the Pockels Effect, an increase in length of the modulator reduces the bandwidth. This is undesirable. High voltages may be compensated with radio frequency (RF) amplifiers. However, this solution increases power consumption and reduces bandwidth. This is particularly true for amplifiers with large voltage swing because power proportional is to the voltage swing squared. Thus, it may be challenging to provide optical modulators formed using Pockels Effect materials having the desired performance. Moreover, optical integrated circuits employing such materials may be desired to be integrated with electronic integrated circuits which include drivers and other electrical components. However, the underfill used in integration techniques such as flip-chip bonding may result in microwave losses. This is particularly true for the longer modulators desired for reduced voltage swings. Consequently, techniques for improving performance, particularly for current high frequency applications, are desired.

### BRIEF DESCRIPTION OF THE DRAWINGS

Various embodiments of the invention are disclosed in the following detailed description and the accompanying drawings.

FIGS. 1A-1E depict embodiments of unit cells for an integrated co-designed photonics device and an embodiment of such a photonics device including a unit cell.

FIGS. 2A-2B depict an embodiment of a unit cell for an integrated co-designed photonics device and an embodiment of the photonics device including a unit cell.

FIG. 3 depicts an embodiment of an integrated co-designed photonics device including an embodiment of unit cell.

FIG. 4 depicts an embodiment of an integrated co-designed photonics device including an embodiment of unit cell.

FIGS. 5A-5B depict embodiments of integrated co-designed photonics devices including embodiments of a unit cell.

FIG. 6 depicts an embodiment of an integrated co-designed photonics device including an embodiment of a unit cell.

FIG. 7 depicts an embodiment of an integrated co-designed photonics device including an embodiment of a unit cell.

FIGS. 8A-8B depict embodiments of integrated co-designed photonics devices including an embodiment of a unit cell.

FIG. 9 depicts an embodiment of an integrated co-designed photonics device including an embodiment of a unit cell.

FIG. 10 depicts an embodiment of an integrated co-designed photonics device including an embodiment of a unit cell.

FIG. 11 depicts a block diagram of an embodiment of an integrated co-designed photonics device including an embodiment of a unit cell.

FIG. 12 is a flow chart depicting an embodiment of a method for providing an integrated co-designed photonics device including an embodiment of a unit cell.

FIG. 13 is a flow chart depicting an embodiment of a method for using an integrated co-designed photonics device including an embodiment of a unit cell.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A photonics device is described. The photonics device includes a plurality of unit cells. Each of the unit cells includes a first portion of a waveguide, an electrode section proximate to the first portion of the waveguide, and an integrated circuit (IC) driver coupled to and configured to drive the electrode section. The unit cells are adjacent and distributed along a second portion of the waveguide. The waveguide includes at least one electro-optic material possessing a Pockels Effect. In some embodiments, the electro-optic material(s) possess the Pockels Effect include one or more of thin film lithium niobate, thin film lithium tantalate, aluminum oxide, electro-optic polymers, liquid crystals, or barium titanate. The waveguide is also configured to carry an optical signal. The IC driver, the electrode section, and the first portion of the waveguide for each of the unit cells are integrated into the photonics device. The unit cells are configured such that the PIC has a 3 dB bandwidth of at least 70 GHz with respect to 1 GHz and the first portion of the waveguide has a length not exceeding five hundred micrometers. The 3 dB bandwidth may be at least 100 GHz. In some embodiments, the electrode section is single ended, differential, terminated, and/or unterminated.

In some embodiments, the IC driver of each of the unit cells is configured with a timing and an order with respect to remaining IC drivers of the unit cells. Each of the unit cells drives the electrode section with the timing and the order corresponding to the speed of the optical signal in the waveguide. The timing is digitally controlled for the IC driver. In some embodiments, the IC driver is a CMOS driver. In some such embodiments, the CMOS driver is in a CMOS IC, the waveguide resides in an optical IC, and the CMOS IC is integrated with the optical IC into the photonics device through an intermediate layer that may include an underfill, a redistribution layer (RDL), and/or other advanced packaging materials. Thus, the electrode section may be connected with the IC driver through a conductive channel (e.g. an electrical connection through the intermediate layer) having a length not exceeding three hundred or four hundred micrometers. In some such embodiments, the electrode section is aligned with the IC driver so that the electrode section is electrically connectable with the IC driver with solder bumps, a conductive via, an RDL, and/or other advanced packaging techniques (e.g., 2.5D or 3D techniques). In some embodiments, a large number of unit cells are used. For example, at least eight or at least ten unit cells may be used. In some embodiments, fewer cells (e.g. at least three) might be used. In some embodiments, the length of the first portion of the waveguide, or the electrode sections, in the unit cell is at least fifty micrometers and not more than five hundred micrometers. The length may be not more than four hundred micrometers in some embodiments. The length of the first portion of the waveguide may be at least one hundred micrometers and not more than two hundred micrometers. In some such embodiments, the electrode section is unterminated.

In some embodiments, the unit cells (e.g., the collection of unit cells in a modulator) provide a phase shift of at least 0.3 multiplied by π and have a V-pi not exceeding 2.5 volts. Iin some such embodiments, each of the unit cells provides not more than ⅛ of the phase shift. In some embodiments, the plurality of unit cells has an impedance of not more than 100 Ohms, 80 Ohms, 70 Ohms, 60 Ohms, 50 Ohms, or 40 Ohms and at least 5 Ohms differential. Each of the unit cells may include a serializer coupled with the IC driver. In some embodiments, the IC driver includes a limit amplifier. In some embodiments, the IC driver includes an active load. The photonics device may configure the unit cells are configured as an optical modulator or an optical digital-to-analog converter.

A photonics device including an electro-optic integrated circuit and a CMOS integrated circuit is described. The electro-optic integrated circuit includes a first portion of each of a plurality of unit cells. Each unit cell includes a first portion of a waveguide, an electrode section proximate to the first portion of the waveguide, and an integrated circuit (IC) driver coupled to and configured to drive the electrode section. The unit cells are adjacent and distributed along a second portion of the waveguide. The waveguide includes at least one electro-optic material possessing the Pockels Effect and is configured to carry an optical signal. The first portion of each unit cell of the electro-optic integrated circuit includes the first portion of the waveguide and the electrode section. The electrode section is unterminated. The CMOS integrated circuit is flip-chip coupled with the electro-optic integrated circuit. The CMOS integrated circuit includes the IC driver for each of the unit cells. The IC driver is aligned with the electrode section such that the IC driver is connectable to the IC driver by solder bumps, RDL, advanced packaging, or a conductive via. Thus, the IC driver is connectable to the electrode sections by a connector (or conductive electrical channel) having a length not exceeding three hundred or four hundred micrometers. The IC driver is configured to drive the electrode section with a logical signal and includes an active device. The unit cells are configured such that the photonics device has a 3 dB bandwidth of at least 100 GHz and the plurality of unit cells has an input impedance of not more than eighty Ohms differential. For example, the unit cells may have a differential impedance of impedance of not more than 100 Ohms, 80 Ohms, 70 Ohms, 60 Ohms, 50 Ohms, or 40 Ohms. In some embodiments, the length of the first portion of the waveguide is at least fifty micrometers and not more than two hundred micrometers.

A method is described. The method includes providing an optical signal to a waveguide and driving an electrode section in each unit cell of a plurality of unit cells of a photonics device. Each of the unit cells includes a first portion of the waveguide, the electrode section proximate to the first portion of the waveguide, and an integrated circuit (IC) driver coupled to and configured to drive the electrode section. The plurality of unit cells is adjacent and distributed along a second portion of the waveguide. The waveguide includes at least one electro-optic material possessing a Pockels Effect. The IC driver, the electrode section, and the first portion of the waveguide for each of the unit cells are integrated into the photonics device. The driving the electrode section further includes driving, using the IC driver, the electrode section of each unit cell with a timing and an order with respect to remaining IC drivers of the plurality of unit cells. The timing and the order correspond to a speed of the optical signal in the waveguide. The timing is digitally controlled for the IC driver. The unit cells are configured such that the photonics device has a 3 dB bandwidth of at least 70 GHz and the first portion of the waveguide has a length not exceeding five hundred micrometers.

Various features of the electro-optic devices are described herein. One or more of these features may be combined in manners not explicitly described herein. The optical devices described herein may be formed using electro-optic materials, such as thin film lithium-containing (TFLC) electro-optical materials. For example, thin film lithium niobate (TFLN) and/or thin film lithium tantalate (TFLT) may be used for the components described. TFLC optical devices use layer(s) of TFLC material that may have a thickness not exceeding three micrometers prior to fabrication of components, such as waveguides, therein. In some embodiments, the TFLC may have a thickness of not greater than one micrometer prior to fabrication of components therein. In general, components are thinner. For example, a TFLC waveguide in an optical modulator may include a ridge and a slab portion. The total thickness of the waveguide (e.g. ridge height plus slab height) may be less than one micrometer as-fabricated. In some embodiments, the total thickness of the waveguide may not exceed five hundred nanometers as-fabricated. In some embodiments, the total thickness of the waveguide may not exceed four hundred nanometers as-fabricated. In some embodiments, the total thickness of the waveguide may not exceed three hundred nanometers as-fabricated. Other thicknesses are possible. Because TFLN is frequently used in such TFLC devices, the systems, methods, and techniques described herein may be discussed in the context of TFLN. However, one of ordinary skill in the art will recognize that the techniques described herein apply to other TFLC devices (e.g. TFLT devices). Wherever a TFLN or thin film lithium niobate integrated circuit is described, a thin film lithium tantalate integrated circuit or other lithium-containing integrated circuit may also be used.

Although primarily described in the context of TFLC electro-optic materials, such as TFLN and TFLT, other nonlinear optical materials may be used in the optical devices described herein. For example, other ferroelectric nonlinear (e.g. second order) optical materials may also be desired to be used in, e.g., waveguides, modulators, polarization rotators, and/or mode converters. Such ferroelectric nonlinear optical materials may include but are not limited to potassium niobate (e.g. KNbO₃), gallium arsenide (GaAs), potassium titanyl phosphate (KTP), lead zirconate titanate (PZT), electro-optic polymers, liquid crystals, and barium titanate (BaTiO₃). The techniques described may also be used for other nonlinear ferroelectric optical materials, particularly those which may otherwise be challenging to fabricate. For example, such nonlinear ferroelectric optical materials may have inert chemical etching reactions using conventional etching chemicals such as fluorine, chlorine or bromine compounds.

In some embodiments, the optical material(s) used are nonlinear. As used herein, a nonlinear optical material exhibits the electro-optic effect and has an effect that is at least (e.g. greater than or equal to) 5 picometer/volt. In some embodiments, the nonlinear optical material has an effect that is at least 10 picometer/volt. In some such embodiments nonlinear optical material has an effect of at least 20 picometer/volt. The nonlinear optical material experiences a change in index of refraction in response to an applied electric field. In some embodiments, the nonlinear optical material is ferroelectric. In some embodiments, the electro-optic material effect includes a change in index of refraction in an applied electric field due to the Pockels effect. Thus, in some embodiments, optical materials possessing the electro-optic effect in one or more the ranges described herein are considered nonlinear optical materials regardless of whether the effect is linearly or nonlinearly dependent on the applied electric field. The nonlinear optical material may be a non-centrosymmetric material. Therefore, the nonlinear optical material may be piezoelectric. Such nonlinear optical materials may have inert chemical etching reactions for conventional etching using chemicals such as fluorine, chlorine or bromine compounds. In some embodiments, the nonlinear optical material(s) include one or more of LN, LT, potassium niobate, gallium arsenide, potassium titanyl phosphate, lead zirconate titanate, electro-optic polymers, liquid crystals, and barium titanate. In other embodiments, other nonlinear optical materials having analogous optical characteristics may be used.

In some embodiments, waveguides and other structures described herein are low optical loss optical structures. For example, a waveguide may have a total optical loss of not more than 10 dB through the portion of waveguide (e.g. when biased at maximum transmission and as a maximum loss) in proximity to electrodes used in modulating the optical signal. The total optical loss is the optical loss in a waveguide through a single continuous electrode region (e.g. as opposed to multiple devices cascaded together). In some embodiments, the waveguide has a total optical loss of not more than 8 dB. In some embodiments, the total optical loss is not more than 4 dB. In some embodiments, the total optical loss is less than 3 dB. In some embodiments, the total optical loss is less than 2 dB. In some embodiments, the waveguide has an optical loss of not more than 3 dB/cm (e.g. on average). In some embodiments, the nonlinear material(s) in the waveguides has an optical loss of not more than 2.0 dB/cm. In some such embodiments, the waveguide has an optical loss of not more than 1.0 dB/cm. In some embodiments, the waveguide has an optical loss of not more than 0.5 dB/cm. In some embodiments, the low optical losses are associated with a low surface roughness of the side walls of the waveguides.

The waveguides and other optical structures may have improved surface roughness. For example, the short range root mean square surface roughness of a sidewall of the rib may be less than ten nanometers. In some embodiments, this root mean square surface roughness is not more than five nanometers. In some cases, the short range root mean square surface roughness does not exceed two nanometers. In some embodiments, a waveguide includes a rib portion and a slab portion. The height of such a rib portion is selected to provide a confinement of the optical mode such that there is a 10 dB reduction in intensity from the intensity at the center of the rib at ten micrometers from the center of the rib. For example, the height of the rib is on the order of a few hundred nanometers in some cases. However, other heights are possible in other embodiments. Various other optical components may be incorporated into the waveguide to provide the desired functionality. For example, the waveguide may have wider portion(s) for accommodating multiple modes or performing other functions.

A material that possesses the Pockels Effect, also termed herein a Pockels Effect material (PEM), includes but may not be limited to thin film lithium niobate (TFLN), thin film lithium tantalate (TFLT), aluminum oxide, barium titanate, electro-optic polymers, liquid crystals, and/or other materials possessing the Pockels effect and with which a waveguide may be provided. As used herein, TFLN may also mean TFLT and/or any suitable Pockels Effect material (PEM), particularly such a material that is a thin film. For simplicity, TFLN and/or TFLT are typically used herein. However, TFLN, TFLT and PEM may be considered interchangeable. Thus, a TFLN waveguide, a TFLT waveguide, and a PEM waveguide may be used to refer to a waveguide including a material that possesses the Pockels Effect.

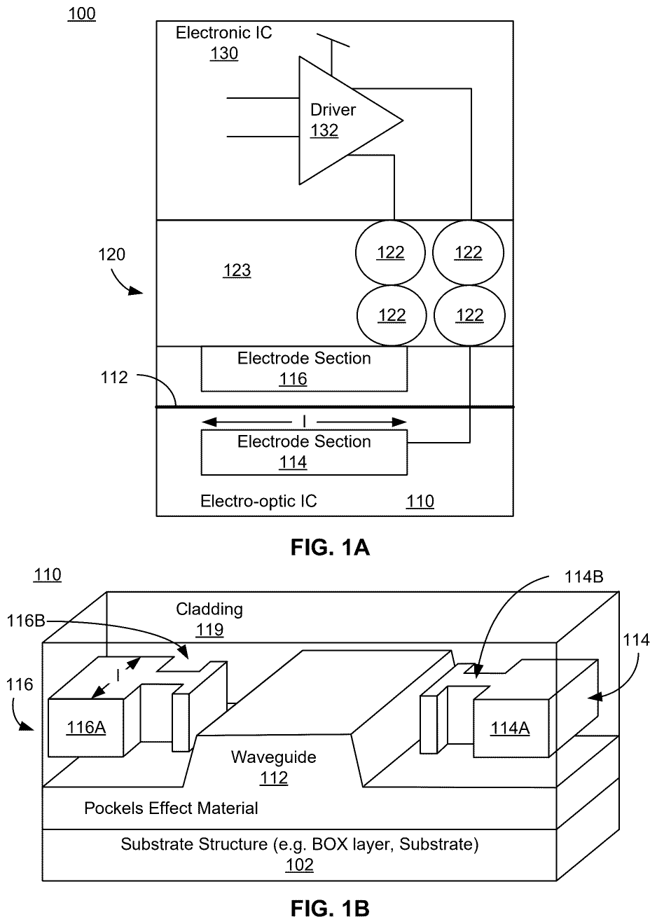

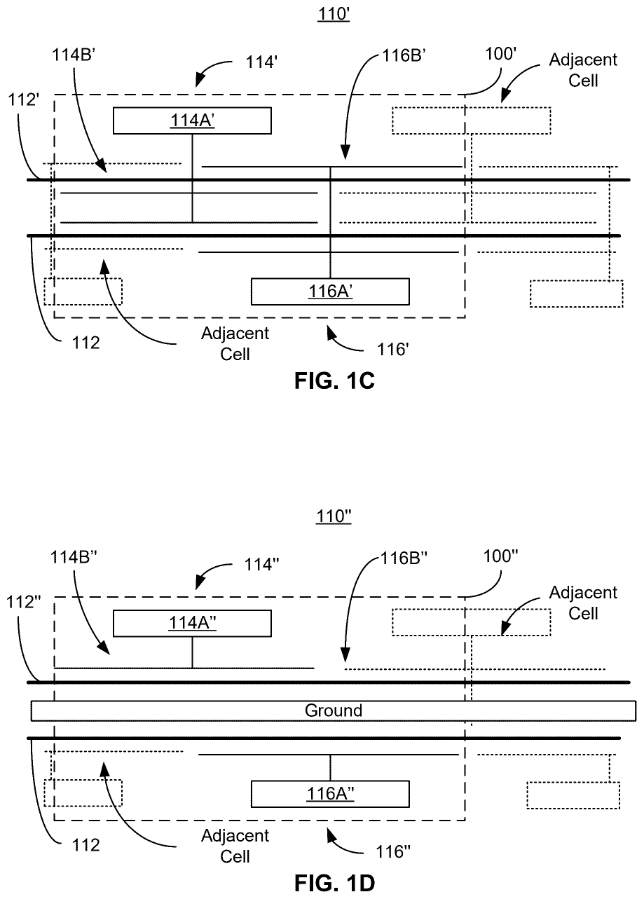

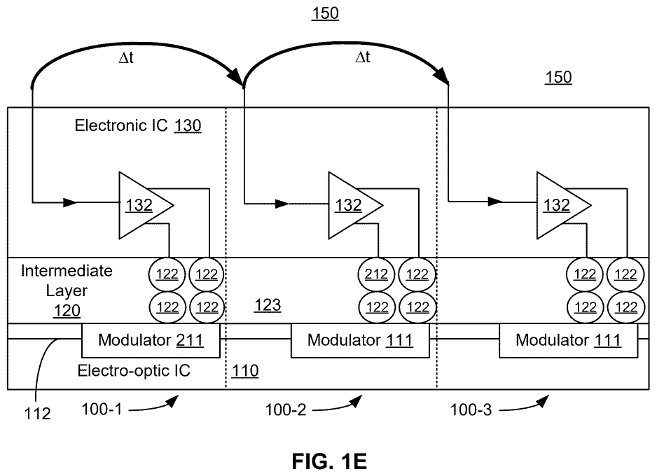

FIGS. 1A-1E depict embodiments of unit cells 100, 100′, and 100″ for an integrated co-designed photonics device and an embodiment of the photonics device 150. FIG. 1A is a diagram of unit cell 100. FIG. 1B is a perspective view of a portion of unit cell 100. FIGS. 1C and 1D are top views of a portion of unit cells 100′ and 100″, respectively. FIG. 1E is a diagram of one embodiment of photonics device 150 formed using unit cells 100. Referring to FIGS. 1A and 1B, unit cell 100 is shown. Unit cell 100 may be configured in various manners to operate on optical signals for particular applications and/or to meet particular requirements, such as voltage swing, phase change (amount of modulation), bandwidth, losses, etc. Multiple unit cells 100 may be combined to provide the desired functions (e.g. total modulation/phase change for the signal for a modulator, frequency of modulation, etc.). of a particular amount). Such unit cells 100 are adjacent to other unit cells. For such adjacent cells, overlap is possible. In some photonics devices including multiple unit cells, unit cells 100 are configured the same. In some photonics devices including multiple unit cells, unit cells may differ.

Unit cell 100 includes portions in electro-optic integrated circuit (IC) 110, intermediate layer 120, and electronic integrated circuit (IC) 130. Stated differently, electro-optic IC 110, intermediate layer 120, and electronic IC 130 contain multiple unit cells 100 to form a photonics device. Electro-optic IC 110 may be coupled with electronic IC 130 using advanced packaging techniques, such as flip-chip bonding through intermediate layer 120 that may include a redistribution layer (RDL). Other advanced packaging techniques including but not limited to 2.5 and 3D techniques may be used to couple electro-optic IC 110 with electronic IC 130. In some embodiments, portions of electro-optic IC 110, intermediate layer 120, and electronic IC 130 corresponding to the same unit cell 100 are aligned. For example, driver 132 may be above and substantially aligned with electrode sections 114 and/or 116. Thus, electro-optic IC 110 and electronic IC 130 are integrated into a photonics device.

Unit cell 100 includes integrated circuit (IC) driver 132 in electronic IC 130, electrical connectors 122 and a portion of underfill 123 in intermediate layer 120, and electrode sections 114 and 116 and a portion of waveguide 112 in electro-optic IC 110. Intermediate layer 120 mechanically and electrically connects electronic IC 130 with electro-optic IC 110. More specifically, electrical connections 122 electrically connect electrode sections 114 and 116 in electro-optic IC with IC driver 132. Electrical connectors 122 may include solder balls (or bumps), conductive pillars (e.g. conductive vias), and/or other structures that provide electrical connection. In some embodiments, electrical connectors 122 have a length not exceeding four hundred micrometers (e.g. the thickness of intermediate layer 120 may be not more than four hundred micrometers). In some embodiments, electrical connectors 122 may have a length of not more than three hundred micrometers. Underfill 123 may provide mechanical connection and electrically insulate connectors 122. Other and/or additional structures may be present in intermediate layer 120.

Electronic IC 130 may be a CMOS IC, such as a SiGe bi-CMOS. For example, electronic IC 130 may be a CMOS IC provided at a particular fabrication node (e.g., 2 nanometers, 3 nanometers, 5 nanometers, 7 nanometers, 10 nanometers, etc.). The node used for electronic IC 130 depends on the configuration of unit cell 100 and the application for which unit cell 100 is to be used. IC driver 132 may include a linear amplifier (e.g. providing an output that is continuous/linear within a particular range based on the input signal) or a limit amplifier (e.g., providing a particular, or maximum, output for an input signal greater than a threshold). For example, a linear amplifier may be used for driving electrode sections 114 and 116 with analog voltages (or currents). A limit amplifier may be used for driving electrode sections 114 and 116 with digital logic voltages. In addition, the amplifiers may employ passive internal loads (e.g., resistors) and/or active internal loads (e.g., transistors).

Electro-optic IC 110 includes a PEM material, such as TFLN and/or TFLT. Such a PEM material forms at least part of waveguide 112 and may reside on an underlying substrate structure 102. Thus, waveguide 112 may be a PEM waveguide, such as a TFLN or TFLT waveguide. This is indicated by waveguide 112 having a ridge structure in FIG. 1B. Substrate structure 102 may include a substrate such as silicon and a thicker buried oxide (BOX) layer. Other substrate structures may be used in some embodiments.

In addition to a portion of waveguide 112, unit cell 100 includes electrode sections 114 and 116. Electrode sections 114 and 116 are short and driven by IC driver 132. Thus, electrode sections 114 and 116 are not directly connected to other electrodes. Although two electrode sections 114 and 116 and a single waveguide 112 are shown, another number may be present. For example, a waveguide pair (e.g., arms split from a waveguide in a Mach-Zehnder configuration) may be proximate to electrode sections 114 and 116. Further, ground line(s) (not shown) may be present. Electrode sections 114 and 116 may be single ended or differential and may have various configurations. For example, electrode sections 114 and 116 may be in a ground-signal-ground (GSG), GSSG, GSGSG, or other configurations. Electrode sections 114 and 116 may be terminated or unterminated (e.g. no load between electrode sections 114 and 116). Although unterminated electrodes may be subject to reflections, electrode sections 114 and 116 are sufficiently short and have a sufficiently low impedance that adverse effects due to such reflections are sufficiently mitigated. For example, electrode sections 114 and 116, and thus the corresponding portion of waveguide 112 have a length, l. For terminated electrodes, this length may be 0.5 millimeters (five hundred micrometers) through ten millimeters. For unterminated electrodes, the length l may be significantly shorter. In some such embodiments, l is at least fifty micrometers and not more than five hundred micrometers. This length may be not more than four hundred micrometers or not more than three hundred micrometers. In some such embodiments, l is at least one hundred micrometers. In some embodiments, l may be at least one hundred micrometers and not more than two hundred micrometers. Other lengths are possible. In some such embodiments, the length of electrode sections 114 and 116 (or the corresponding portion of waveguide 112) is at least 125 micrometers and not more than 175 micrometers (e.g., nominally 150 micrometers). Unterminated electrode sections 114 and 116 may be desired to be shorter to reduce the capacitance, improve the RC limit, and/or to reduce unwanted reflections and the attendant losses.

Electrode sections 114 and 116 may also include extensions. One embodiment of such electrode sections is depicted in FIG. 1B. Thus, electrode section 114′ includes channel region 114A and extensions 114B. Similarly, electrode section 116 includes channel region 116A and extensions 114B. Extensions may have other configurations. For example, FIG. 1C depicts a portion of unit cell 100′ (denoted by a dashed rectangle) on a portion of electro-optic IC 110′. Unit cell 100′ and electro-optic IC 110′ are analogous to unit cell 100 and electro-optic IC 110. Thus, waveguides 112 and 112′ are analogous to waveguide 112 (e.g., may include PEM(s)). Similarly, electrode sections 114′ and 116′ are analogous to electrode sections 114 and 116. Two waveguides 112 and 112′ may form part of a Mach-Zehnder modulator. Electrode sections 114′ and 116′ include channel regions 114A′ and 116A′ and extensions 114B′ and 116B′. Electrode sections for adjacent unit cells are shown in dotted lines. Extensions 114B′ extend across waveguide 112′. Extensions 116B′ extend across the waveguides 112 and 112′. Thus, both waveguides 112 and 112′ are exposed to a voltage difference between extensions 114B′ and 116B′, but with opposite polarity.

In another example, FIG. 1D depicts a portion of unit cell 100″ (denoted by a dashed rectangle) on a portion of electro-optic IC 110″. Unit cell 100″ and electro-optic IC 110″ are analogous to unit cell(s) 100/100′ and electro-optic IC 110/110′. Thus, waveguides 112 and 112″ are analogous to waveguide 112 and 112′ (e.g., may include PEM(s)). Similarly, electrode sections 114″ and 116″ are analogous to electrode sections 114/114′ and 116/116′. Two waveguides 112 and 112″ may form part of a Mach-Zehnder modulator. Electrode sections 114″ and 116″ include channel regions 114A″ and 116A″ and extensions 114B″ and 116B″. Electrode sections for adjacent unit cells are shown in dotted lines. Extensions 114B″ and 116″ do not extend across waveguides 112′ or 112″. However, a ground between waveguides 112 and 112″ is explicitly included.

Other configurations of electrode sections including (or omitting) extensions may be present. Embodiments of analogous electrodes including extensions, but which are not divided into electrode sections, may be found in co-pending U.S. patent application Ser. No. 17/843,906, entitled ELECTRO-OPTIC DEVICES HAVING ENGINEERED ELECTRODES, which is a continuation of U.S. patent application Ser. No. 17/102,047 entitled ELECTRO-OPTIC DEVICES HAVING ENGINEERED ELECTRODES, filed Nov. 23, 2020, which claims priority to U.S. Provisional Patent Application No. 62/941,139 entitled THIN-FILM ELECTRO-OPTIC MODULATORS filed Nov. 27, 2019, U.S. Provisional Patent Application No. 63/033,666 entitled HIGH PERFORMANCE OPTICAL MODULATORS filed Jun. 2, 2020, and U.S. Provisional Patent Application No. 63/112,867 entitled BREAKING VOLTAGE-BANDWIDTH LIMIT IN INTEGRATED LITHIUM NIOBATE MODULATORS USING MICRO-STRUCTURED ELECTRODES filed Nov. 12, 2020, all of which are incorporated herein by reference for all purposes. Interleaved differential electrodes are described, for example, in U.S. patent application Ser. No. 18/532,941, filed on Dec. 7, 2023, Entitled Differential Driving of Lithium-containing Electro-optic DEVICES UTILIZING ENGINEERED ELECTRODES, which is incorporated herein by reference for all purposes. In some embodiments, electrode sections described herein may include extensions analogous to those described in the above-identified patent applications. In some embodiments, extensions for electrode sections are differently configured than described in the above-identified patent application.

In some embodiments, unit cells 100, 100′, and/or 100″ are configured such that a photonics device including unit cell 100, 100′, and/or 100″ has a 3 dB bandwidth of at least 70 GHz with respect to 1 GHz. In some embodiments, the 3 dB bandwidth is at least 100 GHz and not more than 200 GHz (e.g. 100-150 GHz, 100-180 GHz, or nominally 150 GHz). In some embodiments, the 3 dB bandwidth may be greater than 200 GHz. In some embodiments, devices 100, 100′, and/or 100″ having the 3 dB bandwidth(s) described may be usable in frequency ranges including frequencies of up to 500 GHz or more. Other bandwidths are possible. Moreover, such bandwidths are possible for low voltage swings. In some embodiments, the voltage swing does not exceed 3 volts. In some embodiments, the voltage swing does not exceed 2.5 volts. In some embodiments, the volage swing does not exceed 1.5 volts.

Unit cell 100, 100′, and/or 100″ works in concert with other unit cells in a photonics device. For simplicity, unit cell 100 is described. However, unit cells 100′ and 100″ operate in an analogous manner and share analogous benefits. In operation, IC driver 132 drives electrode sections 114 and 116 of modulator 111 with a magnitude and timing based on other unit cells. Consequently, the desired optical modulation may be achieved.

For example, FIG. 1E depicts photonics device 150 (optical modulator) including unit cells 100-1, 100-2, and 100-3 (collectively or generically unit cell(s) 100). Each unit cell 100-1, 100-2, and 100-3 is analogous to unit cell 100. Although three cells 100-1, 100-2, and 100-3 are shown for simplicity, another number may be present. For example, greater than six, greater than eight, greater than ten, greater than twenty, or greater than thirty unit cells 100 may be used in some embodiments. The portion of waveguide 112 and electrode sections 114 and 116 are denoted by modulator 111 in each unit cell. The optical signal may be considered to travel from left to right (from unit cell 100-1 to unit cell 100-2, and then to unit cell 100-3) in FIG. 1E. In each unit cell 100-1, 100-2, and 100-3, driver 132 energizes electrode sections 114 and 116 of modulators 111 after the unit cell to the left is energized and before the unit cell to the right is energized. For example, driver 132 of unit cell 100-2 energizes modulator 111 after driver 132 of unit cell 100-2 energizes the corresponding modulator 111 and before driver 132 of unit cell 100-3 energizes the corresponding modulator 111. Thus, each unit cell 100-1, 100-2, and 100-3 modulates the optical signal on the same waveguide 112. In some embodiments, the timing at which driver 132 energizes electrode sections 114 and 116 may be such that the velocity of the optical signal through the portion of waveguide 112 is matched to a desired degree. For example, the driver 132 and electrode sections 114 and 116 may be configured such that an effective electrode signal provided by the plurality of electrodes has an electrode signal speed matched to within one percent, within three percent, within five percent, or within ten percent of the speed of the optical signal. Thus, unit cells 100, 100′ and/or 100″ may be used in optical modulators such as photonics device 150, optical digital-to-analog converters (ODACs), and other devices.

Because the length, l, of electrode sections 114 and 116 and the portion of waveguide 112 corresponding to unit cell 100 is small, velocity matching within a unit cell 100-1, 100-2, or 100-3 may not be strictly performed. Stated differently, velocity matching between an optical signal traveling through the portion of waveguide 112 and the electrode signal provided to electrode sections 114 and 116 may be less of an issue. Instead, time delays for driving electrode sections 114 and 116 between unit cells 100-1, 100-2, and 100-3 may be used for velocity matching.

The performance of photonics devices using unit cells 100 may be improved. In particular, the electro-optic IC portion (electrode sections 114 and 116 and waveguide portion 112 of electro-optic IC 110) are co-designed with the electronic IC portion (driver 132 of electronic IC 130). The electro-optic IC portion 110 and electronic IC portion 130 may be co-designed in terms of impedance, termination, length and capacitance to provide over-all very large bandwidth and low power. For example, the bandwidths described (e.g. at least 70 GHz, at least 100 GHz-200 GHz, or higher) may be achieved for lower voltage swings, lower power consumption, and desired phase changes (e.g., lower V-pi). For example, unit cells 100, 100′, and 100″ may be used to provide electro-optic ICs 110 having low impedances of not more than fifty Ohm (single-ended), not more than forty Ohms (single ended), not more than thirty Ohms (single ended), not more than twenty Ohms (single ended), not more than ten Ohms (single ended). In some embodiments, therefore, electro-optic ICs 110 used for unit cells 100, 100′, and/or 100″ may have differential impedances of not more than one hundred Ohms, not more than eighty Ohms, not more than sixty Ohms, not more than forty Ohms, or not more than twenty Ohms. In some embodiments, the single-ended impedance of such photonics devices may be at least one Ohm, at least five Ohms, or at least ten Ohms. Such low impedance devices may include IC drivers 132 having active loads. Similarly, the capacitance of such photonics devices may be engineered to be low. In some embodiments, the photonics devices formed using unit cells 100, 100′ and/or 100″ may have a capacitance per unit length of not more than 5 pf/millimeter, not more than 1 pf/millimeter, not more than 0.5 pf/millimeter, not more than 0.4 pf/millimeter and at least 0.1 pf/millimeter. For example, one embodiment of a photonics device using unit cells 100, 100′, and/or 100″ having unterminated electrode sections may be nominally 0.3 pfs/millimeter. As such, a larger range of input impedances may be used and performance may be improved. In embodiments electrode sections 114 and 116 are unterminated. This may allow for voltage doubling for electrode sections 114 and 116, which is desirable. However, RF reflections may also occur. The small length of electrode sections 114 and 116 as well as the low impedance may, however, mitigate this issue.

Because unit cells 100 may result in electro-optic ICs having lower impedances described above, the internal termination for electronic IC 130 may be significantly lowered. For example, the internal termination for electronic IC 130 may be in the same ranges as the impedance for electro-optic IC 510. For example, electronic IC 130 may have an internal termination impedance of at least ten Ohms and not more than twenty Ohms in some embodiments. This may significantly reduce the power consumption, for example where IC drivers 132 use active loads. This also makes the designs of baluns that may be used in conjunction with photonics devices employing unit cells 11.800. Baluns may be used in converting differential GSSG to single-ended GSG, or vice versa. Stated differently, a balun may be used in converting between differential and single ended driving. The use of a balun to match differential to single-ended impedance may be very beneficial for low impedance, low capacitance operation. For example, a twenty Ohm single-ended electrode and a balun may be used to match it to twenty Ohm differential GSSG configuration. Such a balun may be implemented on the electro-optic IC 110, intermediate (advanced packaging) layer 120 and/or electronic IC (CMOS) 130.

Further, unit cell 100 breaks the bandwidth voltage trade-off of conventional modulators utilizing PEMs. A conventional transmission line modulator has a bandwidth that decreases with increasing length of the modulator (or increasing length of the modulation region-the region in which the electrodes are proximate to the waveguide and can modulate the optical signal). For conventional PEMs, the voltage swing may be reduced by increasing the length of the modulator. In contrast, for a photonics device such as a modulator formed using unit cells 100, the length of the modulator (or modulation region) may be increased by adding more unit cells 100. (e.g. to reduce voltage, the bandwidth does not need to be reduced by added length of a modulator). A longer modulator formed using unit cells 100 simply adds more unit cells 100, each of which is driven by IC driver 132. Adding more unit cells (i.e. driver 132, corresponding electrode sections 114 and 116 and corresponding waveguide(s) 112/112′/112″) reduces the V-pi and adds more modulation. However, the bandwidth of such a modulator may not be decreased in a similar manner. Surprisingly, the use of short electrode sections 114 and 116 of unit cell 100 that are separately driven and/or photonic device unit cells 100 described herein allow for not only an increased operational bandwidth even for a longer optical modulator (which thus may have a higher phase shift), but also a higher bandwidth for the co-designed electrode drivers that may be operated at lower swing voltages.

The ability to provide higher band width in conjunction with a larger modulation (e.g. though longer modulators/more unit cells 100) may allow for a significant improvement of the photonics devices (including but not limited to optical modulators). Unit cells 100 may also be used in other efficient devices, such as optical digital to analog converters (ODACs). In other modulator platforms, the bandwidth is not limited by the modulator length but for example by carrier mobility (e.g., in silicon photonics). An advantageous regime for unit cells 100 is reached in Pockels Effect modulators (e.g. TFLN, BTO, polymer). The combination of high bandwidth and low voltage requirements of TFLN may allow the photonics devices to reach the extremely high bandwidths with very low voltage swing as described herein. For example, in some embodiments, a bandwidth of at least 70 GHz, at least 100 GHz or more may be achievable with very low voltage swing, e.g., differential voltage swings of than 1.5 V peak-to-peak, less than 1.25 V peak-to-peak, or less than 1V peak-to-peak.

In similar modulator platforms (e.g., conventional TFLN modulators), the use of larger numbers of the photonics building blocks described herein may have been disfavored because of the belief that the increased complexity would not bring significant benefits. However, as described herein, for sufficiently short electrode section 114 and 116/portion of waveguide 112, such benefits may be achieved. Further, techniques such as flip-chip may have been disfavored because of the traveling wave microwave signal is subject to losses due to underfill 123. These losses may be significantly mitigated by the use of short electrode sections, which may reduce such losses in the underfill. Velocity matching, which is challenging in TFLN and TFLT, may also be improved because the driving of the electrode sections 114 and 116 may be timed to match or substantially match the speed of the optical signal in the waveguide. This is particularly true for embodiments in which the timing is digitally controlled. Further, because electrode sections 114 and 116 of each unit cell 100 are individually driven by the corresponding IC driver 132, electrodes need not cross waveguides 112. Instead, the polarity of the voltage driven by electrode sections 114 and 116 may be reversed. Thus, due to the co-design of driver 132 of electrical (e.g., CMOS) IC 130, PEM waveguide 112/112′/112″, and electrode sections 114 and 116, 114′ and 116′, and 114″ and 116″, performance of photonics devices built using unit cells 100, 100′, and/or 100″ may be improved.

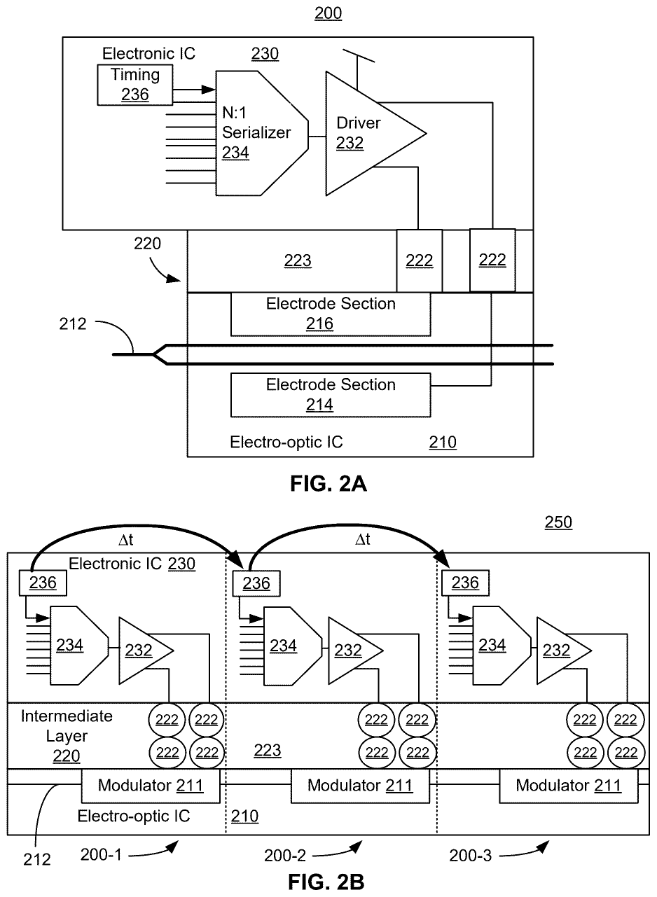

FIGS. 2A-2B depict an embodiment of unit cell 200 for an integrated co-designed photonics device and an embodiment of corresponding photonics device 250. FIG. 2A depicts unit cell 200, while FIG. 2B depicts three corresponding unit cells 200-1, 200-2, and 200-3 for photonics device 250. Referring to FIG. 2A, unit cell 200 is analogous to unit cells 100, 100′, and 100″. Unit cell 200 includes electro-optic IC 210, intermediate layer 220, and electronic IC 210 that are analogous to electro-optic IC 110/110′/110″, intermediate layer 120, and electronic IC 130. Thus, electro-optic IC 210 includes waveguide 212 and electrode sections 214 and 216 that are analogous to waveguide 112/112′/112″ and electrode sections 114/114′/114″ and 116/116′/116″, respectively. Waveguide 212 includes a splitter and two arms proximate to electrode sections 214 and 216. Electro-optic IC 210 of unit cell 200 is configured as a Mach-Zehnder modulator. In some embodiments, electrode sections 214 and 216 are unterminated in some embodiments. Electrode sections 214 and 216 may be terminated in other embodiments. In some embodiments, electrode sections 214 and 216 are configured as differential electrodes for unit cell 200. Thus, electrode sections 214 and 216 in combination with a corresponding portion of waveguide 212 may be considered a differential modulator 211 (labeled in FIG. 2B) for unit cell 200. Intermediate layer 220 of unit cell 200 includes underfill 223 and electrical connections 222 (solder bumps in the embodiment shown) that are analogous to underfill 123 and electrical connections 122. Electronic IC 230 of unit cell 200 includes driver 232.

Electro-optic IC 210 and electronic IC 230 of unit cell 200 may be co-designed as described in the context of unit cells 100, 100′, and 100″. For example, waveguide 212 may be a PEM waveguide such as TFLN and/or TFLT, electrode sections 214 and 216 (as well as a corresponding portion of waveguide 212) may have the lengths described for unit cells 100, 100′, and/or 100″. Similarly, a photonics device formed using unit cell 200 may have bandwidth, voltage swing, power consumption, and other characteristics described in the context of unit cells 100, 100′, and 100″.

In addition, electronic IC 230 includes serializer 234 and timing block 236. In the embodiment shown, serializer 234 is an N:1 serializer. Thus, unit cell 200 may be driven by a digital logic signal (e.g., a logic 0 or 1 that may be provided via flip flops) rather than by an analog waveform having multiple levels. In some embodiments, driver 232 is a limit amplifier instead of a linear amplifier. In other embodiments, other amplifiers might be used.

In operation, digital data provided to unit cell 200 in parallel data lines at a reduced clock speed. A buffer (not shown) in physical proximity driver 232 may temporarily store the data. In some embodiments, such a buffer is part of unit cell 200. In some embodiments the buffer is separate from unit cell 200. Serializer 234 increases the baud rate of the logical data to high baud rate (e.g. 224 Gbaud) and provides the logical data in series to driver 232. The higher speed data provided by serializer 234 is still considered as a logic signal utilizing logical zeroes and ones. Driver 232 may be optimized for well-defined logical bits with known bandwidth and characteristics, rather than analog waveforms. Based on the input logical signal, driver 232 provides a signal to electrode sections 214 and 216, which are used to modulate the optical signal traveling through waveguide 212. Thus, unit cell 200 converts the logical signal into the optical signal via electro-optic modulation. Timing between unit cells 200 may be clocked by a precise clock signal that can be controlled (e.g. by a clocked serializer, a clocked shift register, or other mechanism). Clocking is indicated by timing block 236. Unit cell 200 may thus use logical bits to modulate optical an optical signal at high bandwidth (having sharp rise times and flat levels) with controllable timing and delay.

FIG. 2B depicts an embodiment photonic device 250 including unit cells 200. More specifically, unit cells 200-1, 200-2, and 200-3 are shown. Each of unit cells 200-1, 200-2, and 200-3 is analogous to unit cell 200. Additional and/or other unit cells may be part of photonic device 250. In some embodiments, photonic device 250 may be considered an optical digital-to-analog converter (ODAC) because a digital logic signal may be used to modulate (i.e. converted to) an optical signal. Each unit cell 200-1, 200-2, and 200-3 functions in an analogous manner to unit cell 200. Thus, each unit cell 200-1, 200-2, and 200-3 converts a logical signal to optical modulation of the optical signal through waveguide 212 using the corresponding modulator 211.

In operation, logical bits are sent to each unit cell 200-1, 200-2, and 200-3. Each unit cell converts the logical zeroes and ones to driving voltages (or currents) to provide to the corresponding optical modulator 211. Thus, each unit cell 200-1, 200-2, and 200-3 modulates the optical signal on the same waveguide 212. The modulation from each unit cell 200 is added to the optical signal. For three unit cells 200-1, 200-2, and 200-3, a 2-bit ODAC can be implemented (e.g., level 0: 000, Level 1: 001, Level 2: 011, Level 3: 111). By adding more unit cells 200, higher resolution ODACs may be implemented. For this application, logical signals rather than analog waveforms are provided to ODAC 250. The digital bits are provided in parallel to and brought to high clock speed by serializers 234. IC drivers 232 are driven by a logical signal with high bandwidth and precisely clocked via timing block 236, which share timing information. The electro-optic modulation of multiple sections adds up and can from complex waveforms and optical digital to analog conversion.

The performance of photonics devices using unit cells 200 may be improved in a manner analogous to unit cells 100. Photonics devices, such as ODAC 250, share similar benefits as photonics devices utilizing unit cells 100. Electro-optic IC portion s(electrode sections 214 and 216 and waveguide portion 212 of electro-optic IC 210) are co-designed with the electronic IC portions (driver 232 of electronic IC 230, timing block 236, and serializer 234). The electronic and electro-optic portions of unit cells 200 may be co-designed in terms of impedance, termination, length and capacitance to provide over-all very large bandwidth and low power. Electrode sections 214 and 216 may have lengths analogous to those described for electrode sections 114 and 116. The bandwidths, impedances, capacitances, voltage swings and other characteristics of photonic devices (e.g. photonic device 250) fabricated using unit cells 200 may be analogous to those characteristics of photonics devices including unit cells 100. As a result, higher bandwidth and lower swing voltages for longer modulators (or ODACs) may be achieved. Further, high level packaging using techniques such as flip-chip bonding, 2.5D techniques and/or 3D packaging techniques may be utilized while mitigating losses and utilizing precise time delays between unit cells to account for the speed of transmission of the optical signal through waveguide 212 (e.g. velocity matching may be achieved via timing of drivers 232. Consequently, performance may be significantly improved.

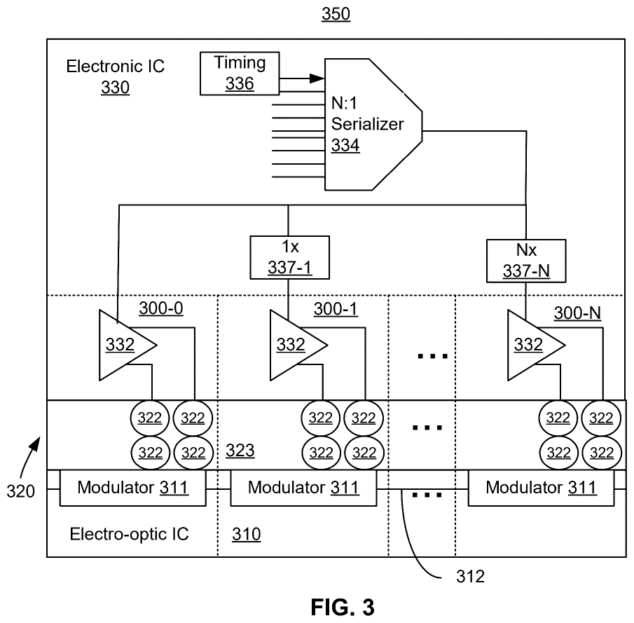

FIG. 3 depicts an embodiment of an integrated co-designed photonics device 350 including an embodiment of a unit cell. Unit cells 300-0, 300-1, through 300-N (collectively or generically unit cell(s) 300) are shown. Unit cells 300 are analogous to unit cells 100, 100′, 100″, and/or 200. Unit cell 300 is most analogous to unit cells 200. Thus, unit cell 300 includes electro-optic IC 310, intermediate layer 320, and electronic IC 310 that are analogous to electro-optic IC 210, intermediate layer 220, and electronic IC 230. Electro-optic IC 310 includes waveguide 312 and modulator sections 311 that are analogous to waveguide 212 and modulator sections 211, respectively. In some embodiments, the electrode sections for modulator sections 311 are unterminated. In some embodiments, modulator sections 311 are configured as differential modulators. Intermediate layer 320 of unit cell 300 includes underfill 323 and electrical connections 322 that are analogous to underfill 223 and electrical connections 222. Electronic IC 330 of unit cell 33 Stop0 includes driver 332 analogous to driver 232 for each unit cell 300. For example, driver 332 may be a limit amplifier instead of a linear amplifier. In other embodiments, other amplifiers might be used.

Instead of each unit cell 300 including a serializer and timing block, electronic IC 330 includes a single serializer 334 and corresponding timing block 336. A single serializer 334 can be used to drive multiple unit cells. For example, N+1 may be 2, 4, 8, 16 or any number. In some embodiments, another number of serializers (less than N+1) may be used. Each unit cell 300 may be optimized for logical bits in an analogous manner to unit cells 200. Fixed or adjustable time delays may be provided between serializer 334 and unit cells 300 by delay blocks 337-1 through 337-N (for N+1 unit cells 300).

Electro-optic IC 310 and electronic IC 330 of unit cell 300 may be co-designed as described in the context of unit cells 100, 100′, 100″, and 200. For example, waveguide 312 may be a PEM waveguide such as TFLN and/or TFLT, electrode sections for modulators 311 (as well as a corresponding portion of waveguide 312) may have the lengths described for unit cells 100, 100′, and/or 100″. Similarly, a photonics device formed using unit cell 300 may have bandwidth, voltage swing, power consumption, and other characteristics described in the context of unit cells 100, 100′, 100″ and/or 200. In addition, unit cells 300 may be driven by a digital logic signal rather than by an analog waveform having multiple levels. Thus, performance and flexibility of photonics devices using unit cells 300 may be improved.

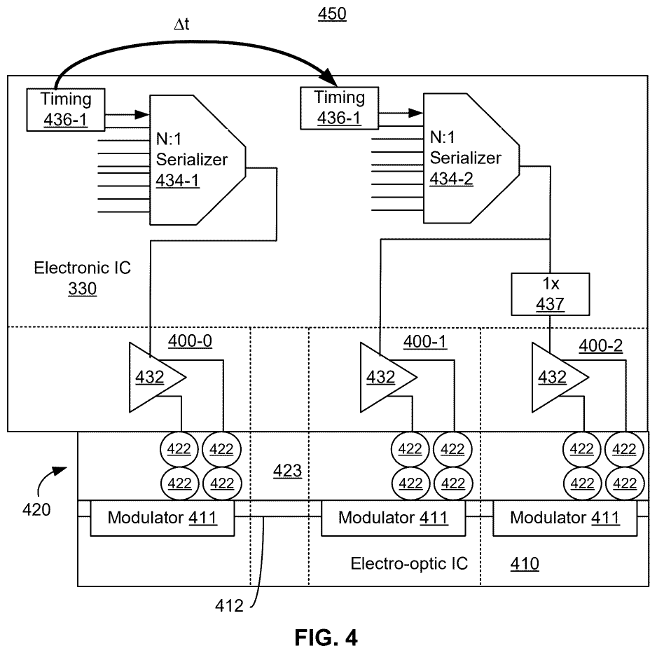

FIG. 4 depicts an embodiment of an integrated co-designed photonics device 450 including an embodiment of a unit cell. Unit cells 400-0, 400-1, and 400-3 (collectively or generically unit cell(s) 400) are shown. Although three unit cells 400 are shown, another number may be present. Unit cells 400 are analogous to unit cells 100, 100′, 100″, 200, and/or 300. Unit cell 400 is most analogous to unit cells 300. Thus, unit cell 400 includes electro-optic IC 410, intermediate layer 420, and electronic IC 410 that are analogous to electro-optic IC 310, intermediate layer 320, and electronic IC 330. Electro-optic IC 410 includes waveguide 412 and modulator sections 411 that are analogous to waveguide 312 and modulator sections 311, respectively. In some embodiments, the electrode sections for modulator sections 411 are unterminated. In some embodiments, modulator sections 411 are configured as differential modulators. Intermediate layer 420 of unit cell 400 includes underfill 423 and electrical connections 422 that are analogous to underfill 323 and electrical connections 322. Electronic IC 430 of unit cell 400 includes driver 432 analogous to driver 332 for each unit cell 400. For example, driver 432 may be a limit amplifier instead of a linear amplifier. In other embodiments, other amplifiers might be used.

Instead of a single serializer and a single timing block for all unit cells 400, electronic IC 430 includes two serializers 434-1 and 434-2 (collectively or generically serializer(s) 434) and two timing blocks 436-1 and 436-2 (collectively or generically timing block(s) 436). First serializer 434-1 and timing block 436-1 are used for unit cell 400-0. Second serializer 434-2 and timing block 436-2 are used for remaining unit cells 400-1 and 400-2. Thus, an additional delay block 437 is used for unit cell 400-2. Delay block 437 is analogous to delay block(s) 337. In other embodiments, one or both serializers 434 may be used to drive another number of unit cells 400. A corresponding number of delay blocks 437 may then be used. Each unit cell 400 may be optimized for logical bits in an analogous manner to unit cells 300.

In photonics device 450, the number of serializers 434 and/or the number of delay blocks 437 may be reduced by grouping unit cells 400 into sets. Further, sets of unit cells 400 may be configured for various types of code. For example, three unit cells 400 with two delays with single unit cells and 1 delay with a group may be used for 2-bit thermometer code. Similarly, 5-bit thermometer code may be achieved using 4 delays with the following groups of unit cells 400: 1, 2, 4, 8, 16 (31 unit cells 400), 30 delays 437 with individual unit cells 400.

Electro-optic IC 410 and electronic IC 430 of unit cell 400 may be co-designed as described in the context of unit cells 100, 100′, 100″, 200, and 300. For example, waveguide 412 may be a PEM waveguide such as TFLN and/or TFLT, electrode sections for modulators 411 (as well as a corresponding portion of waveguide 412) may have the lengths described for unit cells 100, 100′, and/or 100″. Similarly, a photonics device formed using unit cell 400 may have bandwidth, voltage swing, power consumption, and other characteristics described in the context of unit cells 100, 100′, and 100″. In addition, unit cells 400 may be driven by a digital logic signal rather than by an analog waveform having multiple levels. Thus, performance and flexibility of photonics devices using unit cells 400 may be improved.

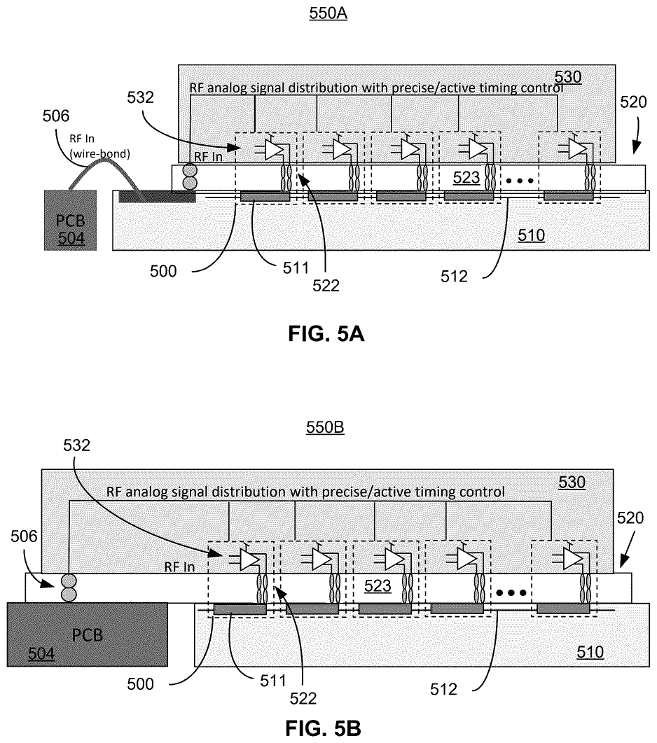

FIGS. 5A-5B depict embodiments of integrated co-designed photonics devices 550A and 550B including embodiments of unit cell 500. Unit cells 500 are analogous to unit cells 100, 100′, 100″, 200, 300, and/or 400. Thus, unit cell 500 includes electro-optic IC 510, intermediate layer 520, and electronic IC 510 that are analogous to electro-optic IC 110, intermediate layer 120, and electronic IC 130. Electro-optic IC 510 includes waveguide 512 and modulator sections 511 that are analogous to waveguide 112 and modulator sections 111, respectively. In some embodiments, the electrode sections for modulator sections 511 are unterminated. In some embodiments, modulator sections 511 are configured as differential modulators. Intermediate layer 520 of unit cell 500 includes underfill 523 and electrical connections 522 that are analogous to underfill 123 and electrical connections 122. Electronic IC 530 of unit cell 500 includes driver 532 analogous to driver 132 for each unit cell 500. For example, driver 532 may be a limit amplifier instead of a linear amplifier. In other embodiments, other amplifiers might be used.

Photonics devices 550A and 550B are configured as analog distributed modulators. Thus, IC drivers 532 (e.g., CMOS drivers) in electronic (CMOS) IC 530 are placed on top of, aligned with, and packaged on PEM (e.g., TFLN and/or TFLT) electro-optic modulator sections 511. Also shown are printed circuit board (PCB) 504 and connectors 506. For photonics device 550A, the electrode RF signal is provided from PCB 504 through electro-optic IC 510 to electronic IC 530. In some embodiments, connector 506 is a RF wire bond. For photonics device 550B, the RF signal is provided from PCB 504 directly to electronic IC 530. In some embodiments, connection is provided between PCB 504 and electronic IC 530 through intermediate layer 530. In photonics device 550B, connector 506 includes solder bumps. However, other connections such as conductive pillars may be used. In photonics devices 550A and 550B, electronic ICs 530 route the RF analog signal to the appropriate unit cells 500. Velocity matching (i.e., the appropriate timing between unit cells 500) may be achieved in the electronic IC 530. Thus, electronic IC 530 may include active control and adjustments for timing of the signals provided to each unit cell 500. For example, an RF transmission line with taps and/or a splitter tree and individual delays may be used. In some embodiments, other techniques may be used. For example, delays between unit cells 500 may be determined and digitally controlled. In various embodiments, different numbers of blocks are used. Further, each unit cell 500 may provide a fraction of the phase shift provided by photonic devices 500A and 500B. For example, if five unit cells 500 are used, each unit cell may provide ⅕ of the phase shift. If 10 unit cells 500 are used, each unit cell may provide 1/10 of the phase shift. If twenty unit cells 500 are used, each unit cell may provide 1/20 of the phase shift. Providing such small fractions of the phase shift is unusual in that for conventional distributed drivers, issues due to RF losses, reduced bandwidth, losses in the underfill, velocity matching and/or other factors may reduce the number of distributed drivers employed.

Photonics devices 500A and 550B may share the benefits described herein. For example, the high bandwidth and low voltage (e.g. a reduced V-pi) may be achieved through the use of short modulator sections 511 sections and a desired number of unit cells. For example, a longer modulator and reduced voltage may be provided decreasing bandwidth. Losses due to underfill 523 may be mitigated due to short electrode sections in modulator sections 511.

Further, photonics devices 500A and/or 500B may be configured for various applications. In some embodiments, CMOS driver 532 may provide approximately a less than 1 V (e.g. nominally 0.8V) peak-to-peak (pp) differential output. CMOS driver 532 may have a 3 dB bandwidth or approximately 200-250 GHz, and approximately 6 mW power consumption. In such embodiments, modulator sections 511 may utilize electrode sections having a length of at least 125 micrometers and not more than 175 micrometers (e.g., nominally 150 micrometers) with a nominal V-pi-L of not more than not more than 2.1V-cm, not more than 1.5 V-cm, and not more than 1.25 V-cm, or not more than 1 V-cm. In such embodiments, modulator sections 511 may use non-terminated true differential electrode sections (allowing for voltage doubling for a differential configuration). Thus, modulator sections 511 may experience a nominally 1.6Vpp differential effective modulation from 0.8V pp driver 532. Such a modulator may achieve a 3 dB bandwidth of at least 150 GHz and not more than 200 GHz (e.g. nominally 170 GHz). This 3 dB bandwidth may be achieved even with losses due to underfill 523, velocity mismatches and reflections due to unterminated electrode sections. In such an embodiment, the phase shift per unit cell 500 may be at least 0.01 multiplied by pi (e.g. nominally 0.013π) for the 0.8Vpp driver 532. Datacom uses approximately a 0.3π phase shift. Thus, photonics devices 550A or 550B used in datacom applications may utilize thirty-two unit cells 500. Photonics devices 550A or 550B used for such applications may consume approximately 192 mW. Telecom utilizes approximately a 1.2π phase shift. Thus, photonics devices 550A or 550B used in telecom applications may include one hundred and twenty-eight unit cells 550. Such photonics devices 550A or 550B used for such applications may consume nominally 768 mW.

In other embodiments, CMOS driver 532 may provide a 1.5-2 V (e.g. nominally 1.8V) pp differential output. CMOS driver 532 may have a 3 dB bandwidth of approximately 100-150 GHz, and approximately 30 mW power consumption. Other embodiments may have power consumption in different ranges, for example from 5 mW through 50 mW per CMOS driver 532. In such embodiments, modulator sections 511 may utilize electrode sections having a length of at least 250 micrometers and not more than 350 micrometers (e.g., nominally 300 micrometers) with a nominally 1.2Vcm V-pi-L. in such embodiments, modulator sections 511 may use non-terminated true differential electrode sections. Thus, modulator sections 511 may experience a nominally 3.6Vpp differential effective modulation from 1.8V pp driver 532. Such a modulator may achieve a 3 dB bandwidth of at least 150 GHz and not more than 200 GHz (e.g. nominally 170 GHz). This 3 dB bandwidth may be achieved even with losses due to underfill 523, velocity mismatches and reflections due to unterminated electrode sections. In such an embodiment, the phase shift per unit cell 500 may be at least 0.08 multiplied by pi (e.g. nominally 0.1π) for the 1.8Vpp driver 532. Datacom uses approximately a 0.3π phase shift. Thus, photonics devices 550A or 550B used in datacom applications may utilize three unit cells 500. Photonics devices 550A or 550B used for such applications may consume approximately 90 mW. Telecom utilizes approximately a 1.2π phase shift. Thus, photonics devices 550A or 550B used in telecom applications may include twelve unit cells 550. Such photonics devices 550A or 550B used for such applications may consume nominally 360 mW.

In other embodiments, CMOS driver 532 may provide a 1.2-1.7 V (e.g. nominally 1.5V) pp differential output. CMOS driver 532 may have a 3 dB bandwidth of approximately 100-150 GHz, and approximately 50 mW power consumption. In such embodiments, modulator sections 511 may utilize electrode sections having a length of at least 1.5 millimeters and not more than 2.5 millimeters (e.g., nominally 2 millimeters) with a nominally 2.1V V-pi-L. in such embodiments, modulator sections 511 may use terminated differential electrode sections. Such a modulator may achieve a 3 dB bandwidth of at least 100 GHz and not more than 200 GHz (e.g. nominally 150 GHz). This 3 dB bandwidth may be achieved even with losses due to underfill 523 and velocity mismatches. In such an embodiment, the phase shift per unit cell 500 may be at least 0.08 multiplied by pi (e.g. nominally 0.1π) for the 1.5Vpp driver 532. Datacom uses approximately a 0.3π phase shift. Thus, photonics devices 550A or 550B used in datacom applications may utilize three unit cells 500. Photonics devices 550A or 550B used for such applications may consume approximately 150 mW. Telecom utilizes approximately a 1.2π phase shift. Thus, photonics devices 550A or 550B used in telecom applications may include twelve unit cells 550. Such photonics devices 550A or 550B used for such applications may consume nominally 600 mW.

Thus, unit cells 500 may be configured in various manners to provide the desired performance for various applications in the distributed architecture of photonic devices 550A and 550B. For example, waveguide 512 may be a PEM waveguide such as TFLN and/or TFLT, electrode sections for modulators 511 (as well as a corresponding portion of waveguide 512) may have the lengths described for unit cells 100, 100′, and/or 100″. Electrode sections for modulation sections 511 may be unterminated or terminated. For unterminated electrode sections, differential voltages provided by electronic IC may be doubled. Shorter lengths of the unterminated electrode sections may mitigate issues due to RF reflections. Losses due to underfill 523 may also be mitigated by the configuration of unit cells 500 being driven in a distributed architecture. Photonics devices 550A and 550B formed using unit cell 500 may have a large bandwidth, a reduced voltage swing, lower power consumption, and other characteristics described in the context of unit cells 100, 100′, and 100″. Thus, performance and flexibility of photonics devices 550A and 550B using unit cells 500 may be improved.

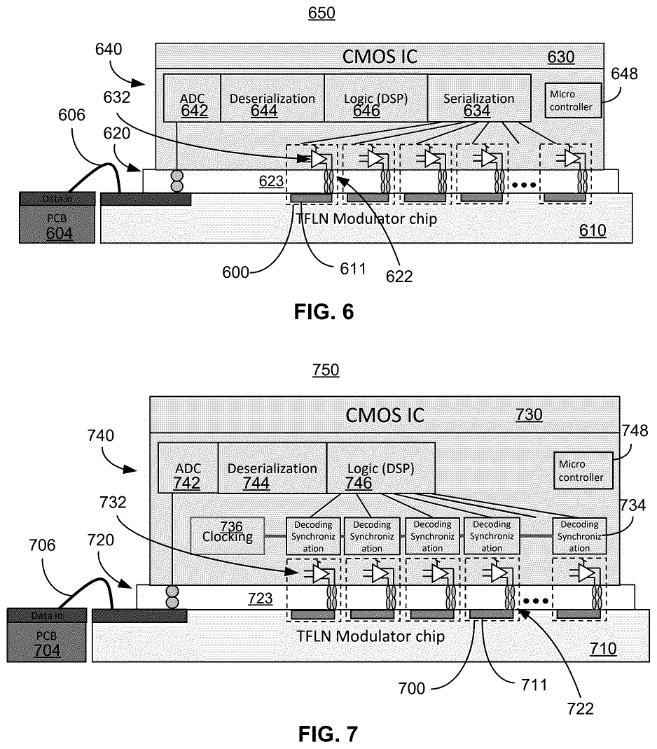

FIG. 6 depicts an embodiment of integrated co-designed photonics device 650 including an embodiment of unit cell 600. Unit cells 600 are analogous to unit cells 100, 100′, 100″, 200, 300, 400, and/or 500. Thus, unit cell 600 includes electro-optic IC 610, intermediate layer 620, and electronic IC 610 that are analogous to electro-optic IC 110, intermediate layer 120, and electronic IC 130. Electro-optic IC 610 includes waveguide 612 and modulator sections 611 that are analogous to waveguide 112 and modulator sections 111, respectively. In some embodiments, the electrode sections for modulator sections 611 are unterminated. In some embodiments, modulator sections 611 are configured as differential modulators. Intermediate layer 620 of unit cell 600 includes underfill 623 and electrical connections 622 that are analogous to underfill 123 and electrical connections 122. Electronic IC 630 of unit cell 60 You started out0 includes driver 632 analogous to driver 132 for each unit cell 600. For example, driver 632 may be a limit amplifier instead of a linear amplifier. In other embodiments, other amplifiers might be used.

In addition, electronic IC 630 includes additional components 640. Additional components 640 include analog-to-digital converter (ADC) 642, deserialization 644, logic/digital signal processor (DSP) 646, serialization 644, and microcontroller 648. Thus, photonics device 600 is configured as an ODAC. ADC 642 digitizes the input RF signal. Deserialization 644 deserializes the digitized signal to the native CMOS clock rate (e.g. ˜3-5 GHz) of electronic IC 630. Single bits are represented in many buses with lower clock rate (parallel).

Electronic (CMOS) IC 630 receives the input signal from PCB 604 via wire bond 606, through intermediate layer 620. Additional components 640 convert the signal from PCB 604 to a logic signal. Logic 640 may perform bit recovery, error correction and/or pulse shaping. Thus, an NRZ logic signal (at the desired baud rate) is used to drive unit cells 600. The total accumulated phase shift from unit cells 600 is additive in electro-optic IC 710. Thus, multiple unit cells 600 are configures as an ODAC. For example, three unit cells 600 may be used to provide a 2-bit thermometer-code ODAC. Sixteen unit cells 600 may be used to form a 4-bit ODAC. Thirty-two unit cells 600 may be used to form a 5-bit ODAC. Sixty-four unit cells 600 may be used to form a 6-bit ODAC. One hundred and twenty-eight unit cells 600 may be used to form a 7-bit DAC. Another number of unit cells may provide a higher bit encoding DAC. ODAC 650 may share the benefits of the photonic devices and unit cells described herein. Thus, using unit cells 600 in ODAC 650 may significantly reduce the power consumed, increase the bandwidth, and mitigate losses. Further, electronic DAC may not be needed. Further, optimization of wire bond 506 may not be critical because the data signal carried via wire bond 606 may be recovered by DSP 646. Logic 640 may perform bit recovery, error correction and/or pulse shaping. Thus, performance of ODAC 630 may be improved.

FIG. 7 depicts an embodiment of integrated co-designed photonics device 750 including an embodiment of unit cell 700. Unit cells 700 are analogous to unit cells 100, 100′, 100″, 200, 300, 400, 500, and/or 600. Thus, unit cell 700 includes electro-optic IC 710, intermediate layer 720, and electronic IC 710 that are analogous to electro-optic IC 110, intermediate layer 120, and electronic IC 130. Electro-optic IC 710 includes waveguide 712 and modulator sections 711 that are analogous to waveguide 112 and modulator sections 111, respectively. In some embodiments, the electrode sections for modulator sections 711 are unterminated. In some embodiments, modulator sections 711 are configured as differential modulators. Intermediate layer 720 of unit cell 700 includes underfill 723 and electrical connections 722 that are analogous to underfill 123 and electrical connections 122. Electronic IC 730 of unit cell 700 includes driver 732 analogous to driver 132 for each unit cell 700. For example, driver 732 may be a limit amplifier instead of a linear amplifier. In other embodiments, other amplifiers might be used.

In addition, electronic IC 730 includes additional components 740 that are analogous to additional components 640. Additional components 740 include ADC 742, deserialization 744, DSP 746, and microcontroller 748 that are analogous to ADC 642, deserialization 644, and DSP 646, and microcontroller 748. Individual decoders and synchronization blocks 734 and clocking 736 are also provided. Logic 740 may perform bit recovery, error correction and/or pulse shaping. The encoded signal may be distributed by DSP 746, for example by two's complement number for clocking, local decoding, and synchronization by clocking block 736 and bit decoding and synchronization blocks 734. Bits may be distributed at a native clock rate and de-serialized, encoded and timed locally in close proximity to driver 732. Thus, photonics device 700 is also configured as an ODAC. Through the use of unit cells 700, performance of ODAC 730 may be improved.

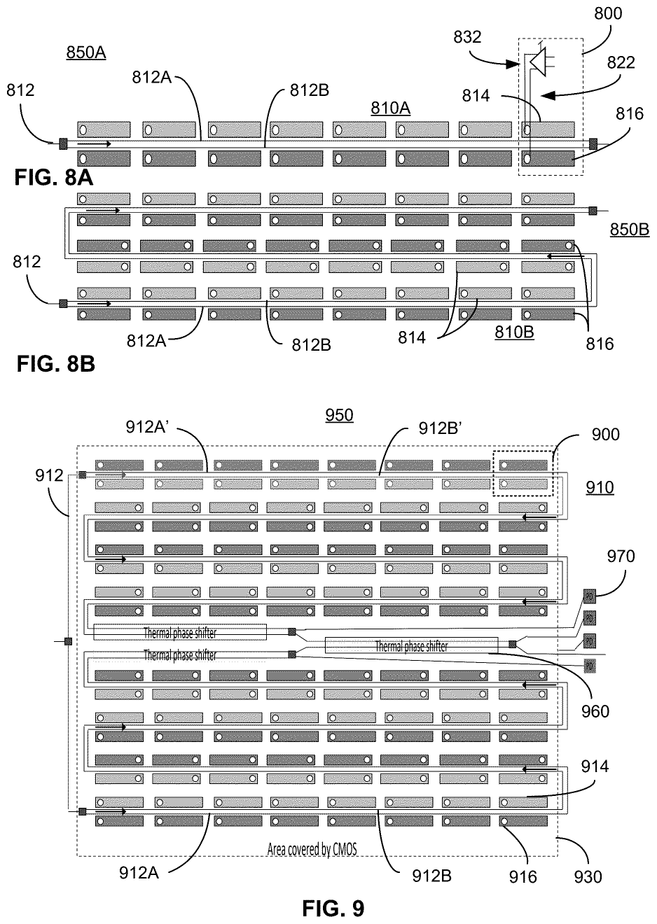

FIGS. 8A-8B depict top views of embodiments of a portion of integrated co-designed photonics devices 850A and 850B including an embodiment of unit cell 800. Unit cells 800 are analogous to unit cells 100, 100′, 100″, 200, 300, 400, 500, 600, and/or 700. Thus, unit cell 800 includes an electronic IC, an intermediate layer (not shown), and electro-optic ICs 810A and 810B that are analogous to electro-optic IC 110, intermediate layer 120, and electronic IC 130. Electro-optic IC 810 includes waveguide 812 and electrode sections 814 and 816 that are analogous to waveguide 112 and electrode sections 114 and 116, respectively. In some embodiments, the electrode sections 814 and 816 are unterminated. In some embodiments, modulator sections corresponding to electrode sections 114 and 116 are configured as differential modulators. The intermediate layer of unit cell 800 includes underfill and electrical connections 822 that are analogous to underfill 123 and electrical connections 122. The electronic IC of unit cell 800 includes driver 832 analogous to driver 132 for each unit cell 800. Photonics devices 850A and 850B might be used for applications such as RF over fiber, a comb generator, and/or in packaged modulator for tasks such as testing and measurement.

Photonics device 850A is a straight modulator including eight unit cells 800. In contrast, photonics device 850B is a modulator including twenty-four unit cells 800. Photonics device 850B is a folding modulator. Thus, waveguide 812 undergoes direction changes. If driven by a transmission line, the arms of waveguide 812 may need to cross to ensure the desired modulation. However, for photonic device 850B, the manner in which electrodes 814 and 816 are driven may be swapped after each one hundred and eighty degree direction change. Thus, the modulation may be controlled without waveguide crossings. This may reduce complexity and loss at crossing elements. Photonics devices 850A and 850B may share the benefits of photonics device 550 such as high bandwidth, low voltage, low impedance, lower power consumed, and/or lower capacitance.

FIG. 9 depicts a top view of an embodiment of a portion of integrated co-designed photonics device 950 including an embodiment of unit cell 900. Photonics device 950 may be used in an in-phase-quadrature (IQ) or DPIQ (dual phase IQ) modulator. Unit cells 900 are analogous to unit cells 100, 100′, 100″, 200, 300, 400, 500, 600, 700, and/or 800. Thus, unit cell 900 includes an electro-optic IC 910, an intermediate layer (not shown), and an electronic IC 930 that is analogous to electro-optic IC 110, intermediate layer 120, and electronic IC 130. Electro-optic IC 910 includes waveguide 912A and 912B (splitting into 912A arms 912B and 912A′ and 912B′) and electrode sections 914 and 916 that are analogous to waveguide 112 and electrode sections 114 and 116, respectively. In some embodiments, the electrode sections 914 and 916 are unterminated. In some embodiments, modulator sections corresponding to electrode sections 114 and 116 are configured as differential modulators. The intermediate layer of unit cell 900 includes underfill and electrical connections that are analogous to underfill 123 and electrical connections 122. The electronic IC 930 of unit cell 900 includes a driver analogous to driver 132 for each unit cell 900. Also shown are thermal phase shifters 960 and photodiodes 970.

Photonic device 950 may include a large number, e.g. eight through one hundred and twenty eight, unit cells 900. In FIG. 9, sixty-four unit cells 900 are shown. In some embodiments, each electrode section 914 or 916 may be nominally 150 micrometers long. Thus, each photonic device 950 may be approximately 5-6 millimeters long and approximately 2-3 mm wide for a single IQ modulator. Thermal phase shifters 960 may be controlled directly from CMOS electronic IC 930 or be routed outside the area where CMOS electronic IC 930 is located. In some embodiments, routing may be done in the CMOS electronic IC 930. Monitor photodiodes 970 may be placed on the complementary ports of the splitters and/or at a power tap of the main output. Photodiodes 970 may be outside the area covered by CMOS electronic IC 930 or below it. Contacts for photodiodes 970 may be below CMOS electronic IC 930 to allow read out. CMOS electronic IC 930 may be either a distributed driver (no logic) or include logic DSP elements and an optical DAC (either all elements are driven with same waveform, or with different logic signals). Thus, photonics device may be configured in multiple manners. Waveguides 912 undergo multiple bends. However, because unit cells 900 are individually driven by drivers in electronic IC 930, waveguide crossings may be reduced or eliminated. Consequently, losses may be reduced. Photonics device 950 may share the benefits of photonics device 550 such as high bandwidth, low voltage, low impedance, lower power consumed, and/or lower capacitance.

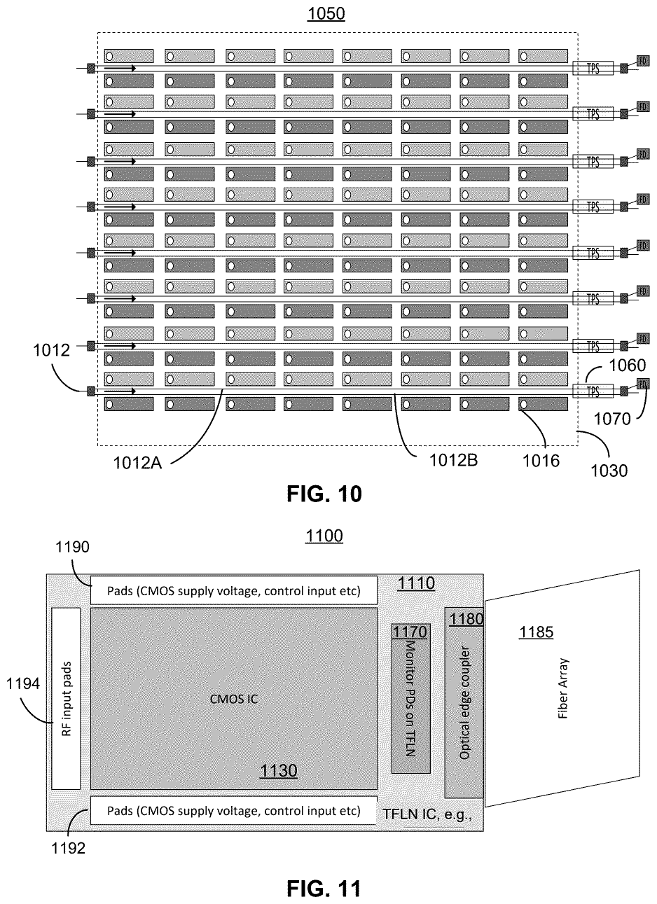

FIG. 10 depicts a top view of an embodiment of a portion of integrated co-designed photonics device 1050 including an embodiment of unit cell 1000. Photonics device 1050 includes eight modulators aligned across photonics device 1050. In some embodiments, photonics device 1050 is an intensity modulator. Unit cells 1000 are analogous to unit cells 100, 100′, 100″, 200, 300, 400, 500, 600, 700, 800, and/or 900. Thus, unit cell 1000 includes an electro-optic IC 1010, an intermediate layer (not shown), and an electronic IC 1030 that is analogous to electro-optic IC 110, intermediate layer 120, and electronic IC 130. Electro-optic IC 1010 includes eight waveguides 1012 (each of which splits into arms 1012A and 1012B) and electrode sections 1014 and 1016 that are analogous to waveguide 112 and electrode sections 114 and 116, respectively. In some embodiments, the electrode sections 1014 and 1016 are unterminated. In some embodiments, modulator sections corresponding to electrode sections 114 and 116 are configured as differential modulators. The intermediate layer of unit cell 1000 includes underfill and electrical connections that are analogous to underfill 123 and electrical connections 122. The electronic IC 1030 of unit cell 1000 includes a driver analogous to driver 132 for each unit cell 1000. Also shown are thermal phase shifters 1060 and photodiodes 1070.

Each modulator for photonic device 1050 may include eight unit cells 1000. In some embodiments, each electrode section 1014 or 1016 may be nominally 150 micrometers long. Thermal phase shifters 1060 may be controlled directly from CMOS electronic IC 1030 or be routed outside the area where CMOS electronic IC 1030 is located. In some embodiments, routing may be done in the CMOS electronic IC 1030. Monitor photodiodes 1070 may be placed on the complementary ports of the splitters and/or at a power tap of the main output. Photodiodes 1070 may be outside the area covered by CMOS electronic IC 1030 or below it. Contacts for photodiodes 1070 may be below CMOS electronic IC 1030 to allow read out. CMOS electronic IC 1030 may be either a distributed driver (no logic) or include logic DSP elements and an optical DAC (either all elements are driven with same waveform, or with different logic signals). Thus, photonics device may be configured in multiple manners. Waveguides 1012 undergo multiple bends. However, because unit cells 1000 are individually driven by drivers in electronic IC 1030, waveguide crossings may be reduced or eliminated. Consequently, losses may be reduced. Photonics device 1050 may share the benefits of photonics device 550 such as high bandwidth, low voltage, low impedance, lower power consumed, and/or lower capacitance.

FIG. 11 depicts a top view of an embodiment of a portion of integrated co-designed photonics device 1150 including an embodiment of unit cell 1100. Photonics device 1150 includes eight modulators aligned across photonics device 1150. In some embodiments, photonics device 1150 is an intensity modulator. Unit cells 1100 are analogous to unit cells 110, 110′, 110″, 200, 300, 400, 500, 600, 700, 800, and/or 900. Thus, unit cell 1100 includes an electro-optic IC 1110, an intermediate layer (not shown), and an electronic IC 1130 that is analogous to electro-optic IC 110, intermediate layer 120, and electronic IC 130. Electro-optic IC 1110 includes eight waveguides 1112 (each of which splits into arms 1112A and 1112B) and electrode sections 1114 and 1116 that are analogous to waveguide 112 and electrode sections 114 and 116, respectively. In some embodiments, the electrode sections 1114 and 1116 are unterminated. In some embodiments, modulator sections corresponding to electrode sections 114 and 116 are configured as differential modulators. The intermediate layer of unit cell 1100 includes underfill and electrical connections that are analogous to underfill 123 and electrical connections 122. The electronic IC 1130 of unit cell 1100 includes a driver analogous to driver 132 for each unit cell 1100. Also shown are thermal phase shifters 1160 and photodiodes 1170.

FIG. 11 depicts a top view of an embodiment of the architecture for a portion of integrated co-designed photonics device 1100 including an embodiment of unit cells analogous to unit cells 110, 110′, 110″, 200, 300, 400, 500, 600, 700, 800, and/or 900. Photonics device 1100 includes electro-optic integrated circuit 1110, electronic IC 1130, photodiodes 1170, optical edge coupler 1180, and pads 1190, 1192, and 1194. Photonics device 1100 is coupled with optical fibers through optical fiber array 1185. In some embodiments, photonics device 1100 is a DPIQ or DR8 device. However, other photonics devices may be similarly configured. Other embodiments having different layouts are also possible. Thus, photonics device 1100 may share the benefits of the photonics devices described herein.

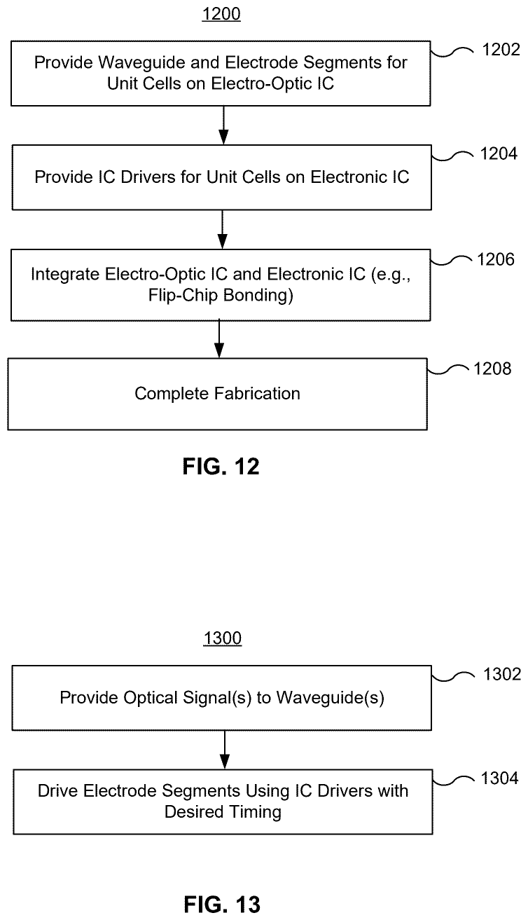

FIG. 12 is a flow chart depicting an embodiment of method 1200 for providing an integrated co-designed photonics device including an embodiment of a unit cell. Method 1200 is described in the context of processes that may have sub-processes. Although described in a particular order, another order not inconsistent with the description herein may be utilized. For example, in some embodiments, portions of processes may be interleaved. Method 1200 is also described in the context of photonics device 150 and unit cell 100. However, method 1200 may be used with other electro-optic devices and/or other unit cells.

An electro-optic IC is fabricated, at 1202. For example, waveguides and electrodes may be provided. Thus, a portion of each unit cell is provided on an electro-optic IC. In some embodiments, 1202 includes obtaining a previously fabricated electro-optic IC.

The electronic IC is fabricated, at 1204. In some embodiments, 1204 includes providing IC drivers for each unit cell. In some embodiments, a previously fabricated electronic IC is obtained at 1204. The electronic IC and electro-optic IC are aligned and integrated, at 1206. This may include using advanced packaging techniques. For example, an electronic IC may be aligned with and flip-chip bonded to the appropriate region of an electro-optic IC. Fabrication may then be completed, at 1208.

For example, in some embodiments, electro-optic IC 110 is provided at 1202. Thus, waveguide 112 and electrode sections 114 and 116 of modulator sections 111 are provided. At 1204, electronic IC 130 is provided. Thus, drivers 132 are formed and/or obtained. At 1206 electronic IC 130 and electro-optic IC 110 are integrated together. For example, electronic IC 130 is flip chip bonded to electro-optic IC 110. Fabrication may then be completed. Thus, using method 1200, the photonics devices and unit cells having the desired configurations are provided. As a result, the benefits described herein may be achieved.

FIG. 13 is a flow chart depicting an embodiment of method 1300 for using an integrated co-designed photonics device including an embodiment of a unit cell. Method 1300 is described in the context of processes that may have sub-processes. Although described in a particular order, another order not inconsistent with the description herein may be utilized. For example, in some embodiments, portions of processes may be interleaved. Method 1300 is also described in the context of photonics device 150 and unit cell 100. However, method 1300 may be used with other electro-optic devices and/or other unit cells.

Optical signal(s) are provided to waveguide(s) of photonics device(s), at 1302. For example, a laser may be optically coupled with the photonics device. Electrode segments of unit cells are driven with the desired timing and order, at 1304. The timing and the order correspond to the speed of the optical signal in the waveguide. The timing may be digitally controlled for the IC driver. In some embodiments, the timing may provide velocity matching between the signals driving electrode sections and the optical signal in the waveguide.

For example, an optical signal may be provided to waveguide 112, at 1302. At 1304, IC driver 132 of unit cell(s) in photonics device 150 drive electrode sections 114 and 116 with the appropriate timing. Thus, the benefits of photonics device 150 using unit cells 10 may be achieved.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A photonics device, comprising:
a plurality of unit cells, each of the plurality of unit cells including a first portion of a waveguide, an electrode section proximate to the first portion of the waveguide, and an integrated circuit (IC) driver coupled to and configured to drive the electrode section, the plurality of unit cells being adjacent and distributed along a second portion of the waveguide, the waveguide including at least one electro-optic material possessing a Pockels Effect and being configured to carry an optical signal;
wherein the IC driver, the electrode section, and the first portion of the waveguide for each of the plurality of unit cells are integrated into the photonics device;
wherein the plurality of unit cells is configured such that the photonics device has a 3 dB bandwidth of at least 70 GHz with respect to 1 GHz and the first portion of the waveguide has a length not exceeding five hundred micrometers.

2. The photonics device of claim 1, wherein the at least one electro-optic material possessing the Pockels Effect includes at least one of thin film lithium niobate, thin film lithium tantalate, aluminum oxide, electro-optic polymers, liquid crystals, or barium titanate.

3. The photonics device of claim 1, wherein electrode section is at least one of single ended, differential, terminated, or unterminated.

4. The photonics device of claim 1, wherein the IC driver of each of the plurality of unit cells is configured with a timing and an order with respect to remaining IC drivers of the plurality of unit cells, each of the plurality of unit cells driving the electrode section with the timing and the order corresponding to a speed of the optical signal in the waveguide, the timing being digitally controlled for the IC driver.

5. The photonics device of claim 1, wherein the IC driver is a CMOS driver.

6. The photonics device of claim 5, wherein the CMOS driver of each of the plurality of unit cells is in a CMOS IC, the waveguide resides in an optical IC, and the CMOS IC is integrated with the optical IC into the photonics device through an intermediate.

7. The photonics device of claim 6, wherein the electrode section is aligned with the IC driver such that the electrode section is electrically connectable with the IC driver through a conductive path through the intermediate layer having a length of not more than three hundred micrometers.

8. The photonics device of claim 1, wherein the plurality of unit cells includes at least eight unit cells.

9. The photonics device of claim 1, wherein the length of the first portion of the waveguide is at least fifty micrometers and not more than five hundred micrometers.

10. The photonics device of claim 9, wherein the length of the first portion of the waveguide is at least one hundred micrometers and not more than three hundred micrometers and wherein the electrode section is unterminated.

11. The photonics device of claim 1, wherein the 3 dB bandwidth is at least 100 GHz.

12. The photonics device of claim 1, wherein the plurality of unit cells provides a phase shift of at least 0.3 multiplied by π and have a V-pi not exceeding 2.5 volts, each of the plurality of unit cells providing not more than ⅛ of the phase shift.

13. The photonics device of claim 1, wherein the plurality of unit cells has a single-ended impedance of not more than 40 Ohms and at least 5 Ohms.

14. The photonics device of claim 1, wherein each of the plurality of unit cells includes a serializer coupled with the IC driver.

15. The photonics device of claim 1, wherein the IC driver includes an active load.

16. The photonics device of claim 1, wherein the IC driver includes a limit amplifier.

17. The photonics device of claim 1 wherein the plurality of unit cells is configured as an optical modulator or an optical digital-to-analog converter.

18. A photonics device, comprising:
an electro-optic integrated circuit including a first portion of each of a plurality of unit cells, each of the plurality of unit cells including a first portion of a waveguide, an electrode section proximate to the first portion of the waveguide, and an integrated circuit (IC) driver coupled to and configured to drive the electrode section, the plurality of unit cells being adjacent and distributed along a second portion of the waveguide, the waveguide including at least one electro-optic material possessing a Pockels Effect and being configured to carry an optical signal, the first portion of each of the plurality of unit cells of the electro-optic integrated circuit including the first portion of the waveguide and the electrode section, the electrode section being unterminated; and
a CMOS integrated circuit coupled with the electro-optic integrated circuit and including the IC driver for each of the plurality of unit cells, the IC driver being aligned with the electrode section such that the IC driver is connectable to the electrode section by an electrical channel having a length of not more than 300 micrometers, the IC driver being configured to drive the electrode section with a logical signal and including an active device;
wherein the plurality of unit cells is configured such that the photonics device has a 3 dB bandwidth of at least 100 GHz and the plurality of unit cells has an input impedance of not more than forty Ohms.

19. The photonics device of claim 18, wherein a length of the first portion of the waveguide is at least fifty micrometers and not more than two hundred micrometers.

20. A method, comprising:
providing an optical signal to a waveguide; and
driving an electrode section in each unit cell of a plurality of unit cells of a photonics device, each of the plurality of unit cells including a first portion of the waveguide, the electrode section proximate to the first portion of the waveguide, and an integrated circuit (IC) driver coupled to and configured to drive the electrode section, the plurality of unit cells being adjacent and distributed along a second portion of the waveguide, the waveguide including at least one electro-optic material possessing a Pockels Effect and being configured to carry the optical signal, the IC driver, the electrode section, and the first portion of the waveguide for each of the plurality of unit cells being integrated into the photonics device, wherein the driving further includes:
driving, using the IC driver, the electrode section of each of the plurality of unit cells with a timing and an order with respect to remaining IC drivers of the plurality of unit cells, the timing and the order corresponding to a speed of the optical signal in the waveguide, the timing being digitally controlled for the IC driver;
wherein the plurality of unit cells is configured such that the photonics device has a 3 dB bandwidth of at least 70 GHz and the first portion of the waveguide has a length not exceeding five hundred micrometers.
